(19) United States
(12) Patent Application Publication
(10) Pub. No.: US 2021/0062970 A1
(43) Pub. Date: Mar. 4, 2021

(54) Lattice Structures

(71) Applicant: Imperial College Innovations Limited, London (GB)

(72) Inventor: Minh-Son PHAM, London (GB)

(21) Appl. No.: 16/634,464

(22) PCT Filed: Jul. 27, 2018
(86) PCT No.: PCT/GB2018/052117

§ 371 Date: Jan. 27, 2020

(30) Foreign Application Priority Data
Jul. 27, 2017 (GB) 1712114.6

(51) Int. Cl. F16S 5/00; B29C 64/393; B33Y 10/00; B33Y 50/02; B33Y 80/00

(52) U.S. Cl. CPC F16S 5/00; B29C 64/393; B33Y 80/00; B33Y 50/02; B33Y 10/00

(57) ABSTRACT

A lattice structure according to an embodiment of the invention comprises a plurality of struts integrally connected to one another at a plurality of nodes, wherein the plurality of struts are arranged into at least a first region comprising a first repeating strut arrangement, a second region comprising a second repeating strut arrangement, the first repeating strut arrangement being different to the second repeating strut arrangement, and a boundary region disposed between the first region and the second region, the boundary region comprising a plurality of struts configured to connect nodes in the first region to nodes in the second region, a strut arrangement in the boundary region being different to the first and second repeating strut arrangements. The first repeating strut arrangement and/or the second repeating strut arrangement may be configured based on a crystallographic lattice, including but not limited to the Bravais lattices. Such an arrangement of lattices can mimic the polygrain structure in crystals so as to enhance the strength and ductility of the lattice structure, using strengthening mechanisms analogous to those in crystalline alloys. Methods and apparatus for designing a lattice structure are also disclosed.

### TECHNICAL FIELD

The present invention relates to lattice structures. More particularly, the present invention relates to lattice structures comprising a plurality of struts integrally connected to one another at a plurality of nodes.

### BACKGROUND

Lattice structures, which may also be referred to as micro-truss structures, comprise a plurality of nodes that are arranged in an orderly fashion throughout the structure. In contrast to conventional honeycomb structures which consist of hollow cells enclosed by walls, lattice structures comprise ordered nodes which are connected by struts to form a continuously periodical three-dimensional lattice. Lattice structures are lightweight, and can absorb significant energy through deformation of the struts. The development of additive manufacturing (AM) techniques, commonly referred to as 3D printing, allows complex lattice structures to be built up layer-by-layer from a computer-aided design (CAD) model. 3D-printed lattice structures can be incorporated within many components in order to reduce the weight and material cost, and the shape of the structure can be customised in order to fit individual needs.

However, the strength of a lattice structure is typically significantly lower than that of a solid part of identical external dimensions made of the same material. For example, if the ratio of the overall density of the lattice structure relative to the density of the solid material is smaller than 0.3, the strength of the lattice structure is typically less than 10% of that of an equivalent solid part. In addition, beyond the elastic limit, lattice structures usually suffer from unstable (or softening) behaviour under external loads, due to the formation of shear bands which cause a substantial reduction in the overall load-bearing capacity of the structure. There is therefore a need in the art for an improved lattice structure, and for methods of designing and manufacturing improved lattice structures with stable or even strengthened behaviour to increase the energy absorption capability of the structure.

### SUMMARY OF THE INVENTION

According to a first aspect of the present invention, there is provided a lattice structure comprising a plurality of struts integrally connected to one another at a plurality of nodes, wherein the plurality of struts are arranged into at least a first region comprising a first repeating strut arrangement, a second region comprising a second repeating strut arrangement, the first repeating strut arrangement being different to the second repeating strut arrangement, and a boundary region disposed between the first region and the second region, the boundary region comprising a plurality of struts configured to connect nodes in the first region to nodes in the second region, a strut arrangement in the boundary region being different to the first and second repeating strut arrangements.

In some embodiments according to the first aspect, the first repeating strut arrangement comprises a first repeating unit which is repeated throughout the first region, and the second repeating strut arrangement comprises a second repeating unit which is repeated throughout the second region, wherein the first and second repeating units have the same number and arrangement of struts and have different physical dimensions. The different physical dimensions of the first and second repeating units may include a different spacing between nodes.

In some embodiments according to the first aspect, the first repeating strut arrangement comprises a first repeating unit which is repeated throughout the first region, and the second repeating strut arrangement comprises a second repeating unit which is repeated throughout the second region, wherein a number and/or orientation of struts in the first repeating unit is different to a number and/or orientation of struts in the second repeating unit.

In some embodiments according to the first aspect, at least one of the first repeating strut arrangement and the second repeating strut arrangement is configured based on a crystallographic lattice. For example, the crystallographic lattice may be a body-centred cubic lattice, face-centred cubic lattice, or hexagonal close-packed lattice.

In some embodiments according to the first aspect, the first repeating strut arrangement and the second repeating strut arrangement are configured based on different crystallographic lattices.

In some embodiments according to the first aspect, the first region is surrounded and enclosed by the second region.

In some embodiments according to the first aspect, one or more of the plurality of struts in the boundary region are bent to accommodate a discontinuity between the first region and the second region.

In some embodiments according to the first aspect, the first and second repeating strut arrangements are configured such that in the boundary region, at least some of the struts of the first region are coincident with at least some of the struts of the second region.

In some embodiments according to the first aspect, the lattice structure is formed by additive manufacturing.

According to a second aspect of the present invention, there is provided a structural component comprising a lattice structure according to the first aspect.

According to a third aspect of the present invention, there is provided a multi-component product comprising a structural component according to the second aspect.

According to a fourth aspect of the present invention, there is provided a computer-readable storage medium arranged to store computer program instructions which, when executed, cause an additive manufacturing apparatus to manufacture a lattice structure according to the first aspect, or a structural component according to the second aspect.

According to a fifth aspect of the present invention, there is provided a computer-implemented method of configuring a lattice structure comprising a plurality of struts integrally connected to one another at a plurality of nodes, wherein the plurality of struts are arranged into at least a first region comprising a first repeating strut arrangement, a second region comprising a second repeating strut arrangement, the first repeating strut arrangement being different to the second repeating strut arrangement, and a boundary region disposed between the first region and the second region, the boundary region comprising a plurality of struts configured to connect nodes in the first region to nodes in the second region, a strut arrangement in the boundary region being different to the first and second repeating strut arrangements, the method comprising defining a three-dimensional shape of each of the first and second regions, and determining positions and orientations of struts within each of the first and second regions by infilling the respective defined three-dimensional shape with the respective first or second repeating strut arrangement.

In some embodiments according to the fifth aspect, the method further comprises determining the strut arrangement in the boundary region to accommodate a discontinuity between the first and second repeating strut arrangements.

In some embodiments according to the fifth aspect, the first region and/or the second region is defined as having a polyhedral shape.

In some embodiments according to the fifth aspect, the method further comprises selecting each of the first and second repeating strut arrangements from a plurality of predefined repeating strut arrangements. Each one of the plurality of predefined repeating strut arrangements may be configured based on a crystallographic lattice.

In some embodiments according to the fifth aspect, an external boundary' of the lattice structure is defined according to physical dimensions of a component in which the lattice structure is to be included.

In some embodiments according to the fifth aspect, the method further comprises a step of controlling a fabrication apparatus to manufacture the lattice structure. For example, the fabrication apparatus may be an additive manufacturing apparatus, which may also be referred to as a 3D printer.

### BRIEF DESCRIPTION OF THE DRAWINGS

Embodiments of the present invention will now be described, by way of example only, with reference to the accompanying drawings, in which:

FIG. 1 illustrates a lattice structure comprising a plurality of regions having different strut arrangements, according to an embodiment of the present invention;

FIG. 2 illustrates unit cells of the lattice structure of FIG. 71, according to an embodiment of the present invention;

FIG. 3 illustrates resistance to shear band propagation under external loads of a lattice structure comprising a plurality of regions similar to the ones shown in FIG. 1, according to an embodiment of the present invention; and

FIG. 4 illustrates examples of unit cells for a plurality of different types of lattice, according to an embodiment of the present invention;

FIG. 5 is a flowchart showing a method of configuring and producing a lattice structure, according to an embodiment of the present invention;

FIG. 6 illustrates a lattice structure comprising one region surrounded and enclosed by another region with a different strut arrangement, according to an embodiment of the present invention;

FIG. 7 is a graph comparing the strength of the lattice structure comprising a plurality of precipitate-like regions similar to the one shown in FIG. 6 against a single cell lattice structure, according to an embodiment of the present invention; and

FIG. 8 schematically illustrates apparatus for configuring and producing a lattice structure, according to an embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the scope of the present invention. Accordingly, the drawings and description are to be regarded as illustrative in nature and not restrictive. Like reference numerals designate like elements throughout the specification.

In embodiments of the present invention, principles of hardening mechanisms in metals at the atomic scale can be applied to the design of lattice structures, in order to provide greater control over the mechanical properties of the structure. By designing lattice structures in this way, it is possible to design structures that have multiple regions with different repeating strut arrangements, and which consequently have the desired mechanical properties. This approach can enable the mechanical properties of lattice structures to be tailored to particular applications. Specific examples of novel types of lattice structures designed in this way, and their associated advantages, will now be described.

In embodiments of the present invention, lattice structures may be produced by 3D printing or any other suitable fabrication process, for example casting using a sacrificial mould. In some embodiments the lattice structure can be a unitary structure, meaning that the structure is formed as a continuous solid body, as opposed to comprising physically separate struts or nodes connected by mechanical fasteners or other means. By forming a continuous lattice structure, the strength can be improved in comparison to a similar structure formed from separate components, by removing potential points of weakness at the joins between components. However, in other embodiments a lattice structure may be formed from multiple separate struts connected together at nodes by suitable fastening means, such as brackets or hinges.

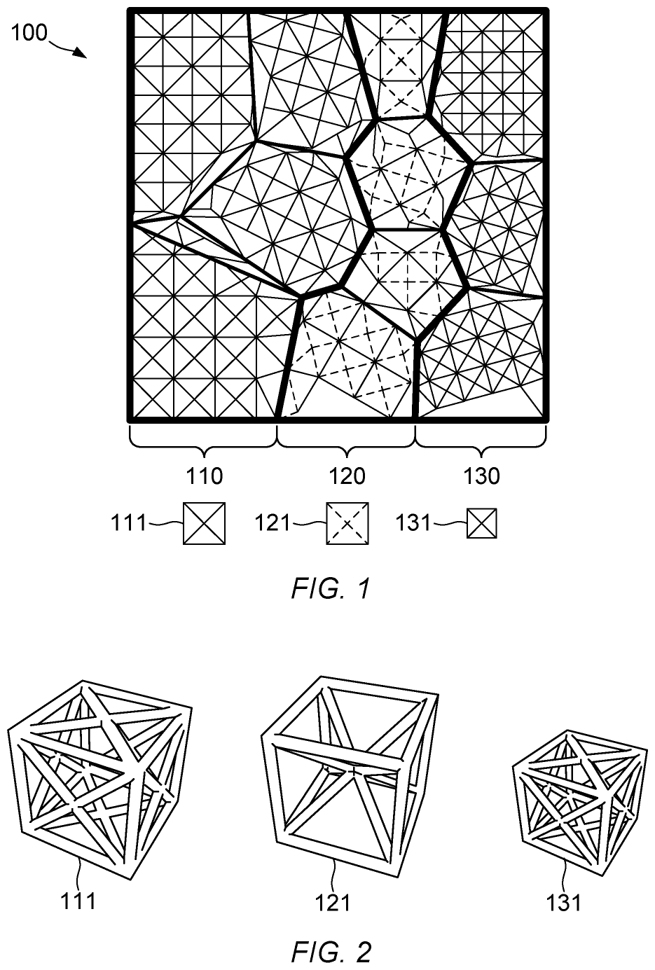

Referring now to FIG. 1, a lattice structure comprising a plurality of regions having different strut arrangements is illustrated, according to an embodiment of the present invention. FIG. 2 illustrates the unit cells of the lattice structure of FIG. 1 in perspective view.

The lattice structure 100 of the present embodiment comprises a plurality of struts integrally connected to one another at a plurality of nodes. Here, the term ‘node’ is used to refer to a point in space at which two or more struts meet. In contrast to a conventional lattice structure which is single-oriented, i.e. constructed from a single repeating unit, the lattice structure of the present embodiment comprises a plurality of regions within which the repeating strut arrangement is different to that in adjacent regions.

The lattice structure of the present embodiment can be thought of as analogous to a poly-crystal microstructure, for example a metallic solid comprising a plurality of grains, but on a macroscopic scale. As such, the plurality of regions in the lattice structure can be configured so as to mimic the polygrain microstructure in crystalline metals. The lattice structure can therefore be described using terminology from the field of crystallography, such as grains, unit cells, grain boundaries, precipitates and phases. Hence, each region of the lattice structure of the present embodiment will hereinafter be referred to as a ‘grain’. Similarly, the repeating strut arrangement within each grain can be referred to as a ‘unit cell’, and the boundaries between adjacent grains can be referred to as ‘grain boundaries’. Where these terms are used in the following description, it should be understood that these refer to features of the lattice structure on the macroscopic scale, as opposed to features on the atomic scale.

In the present embodiment, the plurality of grains can be grouped into a first plurality of grains 110, a second plurality of grains 120, and a third plurality of grains 130. Within the first plurality of grains 110, each grain is constructed from the same unit cell, but the orientation of the unit cell differs between adjacent grains. The same applies to the second plurality of grains 120 and the third plurality of grains 130.

As shown in FIG. 2, in the present embodiment the first plurality of grains 110 and the third plurality of grains 130 each comprise a face-centred cubic (FCC) unit cell 111, 131. Specifically, in the present embodiment each one of the first plurality of grains 110 is constructed from a first FCC unit cell 111, and each one of the second plurality of grains 130 is constructed from a second FCC unit cell 131 with a shorter side length than the first FCC unit cell 111. The first and second FCC unit cells 111, 131 therefore have the same number and arrangement of struts, but have different physical dimensions. Using the crystallography analogy, the first and second FCC unit cells 111, 131 can be considered as having different lattice parameters a, b, c, and therefore the spacing between nodes in the first FCC unit cell 111 is different to the spacing between nodes in the second FCC unit cell 131.

In contrast to the first plurality of grains 110 and the third plurality of grains 130, each one of the second plurality of grains 120 is constructed from a body-centred cubic (BCC) unit cell 121. The second plurality of grains 120 can therefore be thought of as having a different lattice type (BCC) than the first and third plurality of grains 110, 130 (FCC). Since the lattice type of the second plurality of grains 120 is different to that of the first and third plurality of grains 110, 130, the number and orientation of struts in the repeating unit cell 121 of the second plurality of grains 120 is different to the number and orientation of struts in the repeating units 111, 131 of the first and third plurality of grains 110, 130. In this way, the plurality of regions in the lattice structure can be configured so as to mimic different crystalline phases.

In addition to the plurality of grains, the lattice structure of the present embodiment comprises a plurality of boundary regions between the grains, which may be referred to as grain boundaries. Each boundary region comprises a plurality of struts that are configured to connect nodes in the first region to nodes in the second region, thereby physically connecting adjacent grains and providing a continuous lattice structure. Within the boundary regions, the strut arrangement is different to that in the adjacent grains. The struts within a boundary region may either be linear, i.e. straight, or may be non-linear, e.g. curved or formed from a plurality of straight-line segments, in order to accommodate a discontinuity between the adjacent grains. This construction of struts and nodes in the boundary regions is analogous to the atomic arrangements in boundaries between grains in polycrystals.

Since the strut arrangement in the boundary region is different to that in either of the adjacent grains, the boundary region can hinder the propagation of cracks and shear bands from one grain to the next in the lattice structure, analogous to a grain boundary blocking movements of dislocations from one grain to the next on the microscopic scale. Experiments conducted by the inventor have shown that a boundary region between adjacent grains in a lattice structure can help to prevent fast brittle failure of the structure, by stopping a crack from propagating to the neighbouring grain. The boundary regions ensure that the lattice structure as a whole retains strength even after mechanical failure of the structure within one grain, enabling the structure to carry load up to large deformation and thereby increase the energy absorption. For example, in one experiment the energy absorption per unit volume of a lattice structure comprising a plurality of grains separated by boundary regions was observed to be about 1309.3 kJ/m³ (kilojoules per metre cubed), giving an increase of about 670% in comparison to an energy absorption per unit volume of 194 kJ/m³ for a lattice structure comprising the same repeated strut arrangement through the entire structure.

Conventional single-oriented lattice structures can suffer instability during deformation, as a result of formation of shear bands or cracks as the structure deforms. Shear band or crack formation is particularly problematic in lattice structures, in particular for materials with high stiffness such as metals, ceramics or brittle polymers. Shear band formation in a single-oriented lattice structure results in a substantial loss in strength. In addition, even before shear band formation occurs, the initial strength of single-oriented lattice structures is very low compared to the strength of the solid. material from which the structure is formed. In contrast, by providing multiple regions with different strut arrangements such as the one shown in FIG. 1, lattice structures according to embodiments of the present invention can achieve higher strengths than single-oriented lattice structures. Lattice structures according to embodiments of the present invention can also be more resistance to shear band propagation, since it is difficult for shear bands in one region of the structure to propagate into an adjacent region with a different strut arrangement. By tailoring the orientation of struts and the type of lattice in embodiments of the present invention, it will be possible to control the propagation of shear bands or cracks in lattice structures, making the structure more tolerant to the damage. By ‘more tolerant’, it is meant that the impact of the formation of shear bands or cracks on the overall strength of the lattice structure can be reduced.

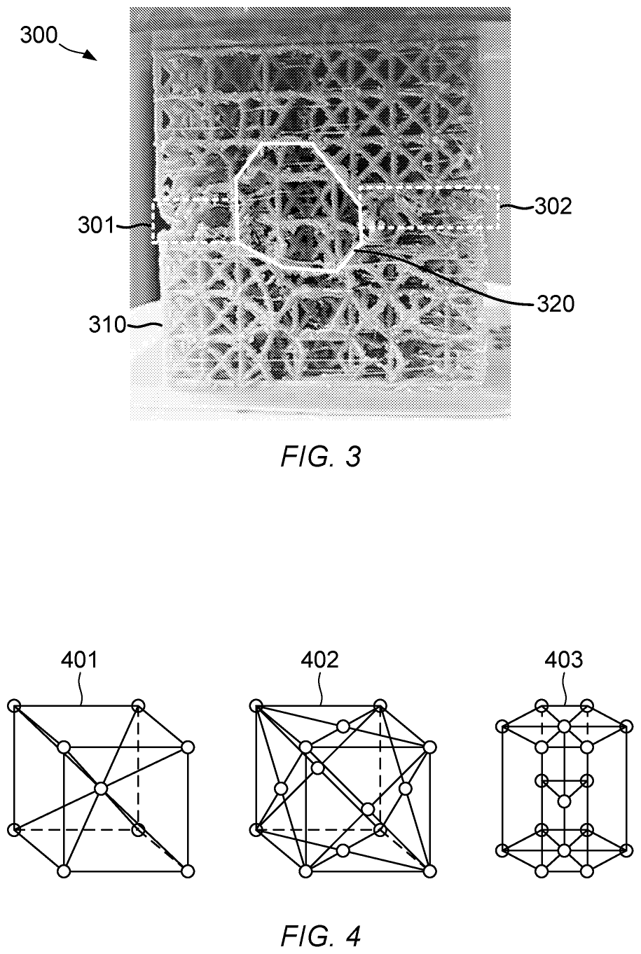

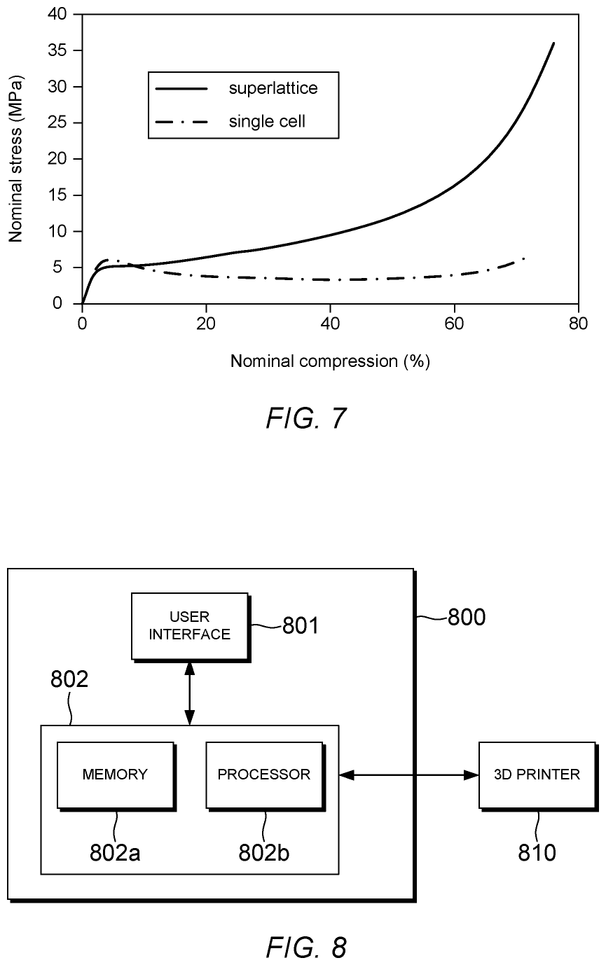

FIG. 3 is a photograph of a physical sample of a lattice structure similar to the one shown in FIG. 1 after mechanical testing, according to an embodiment of the present invention. FIG. 3 illustrates the resistance to shear band propagation of this lattice structure. In the embodiment shown in FIG. 3, the structure 300 comprises a plurality of grain regions 310, 320 constructed from FCC unit cells, similar to the structure shown in FIG. 1. As shown in FIG. 7, during deformation of the lattice structure 300 shear bands 301, 302 have formed on either side of the grain 320, but have been prevented from propagating across the full width of the lattice structure 300 due to the different strut arrangement within the grain 320.

In the embodiment shown in FIG. 1, FCC and BCC unit cells are used. In other embodiments different types of unit cell may be used. The use of different unit cells for different regions in a component may mimic the multi-phases found in polycrystals. Referring now to FIG. 4, examples of unit cells for a plurality of different types of lattice are illustrated, according to embodiments of the present invention. In FIG. 4, the left-hand diagram illustrates a BCC unit cell 401, the middle diagram illustrates a FCC unit cell 402, and the right-hand diagram illustrates a hexagonal close-packed unit cell 403. It will be appreciated that these are just a few examples, and in other embodiments different types of unit cell may be used when designing a region within a lattice structure.

Furthermore, in other embodiments a unit cell may be used which does not have an equivalent crystal lattice system. The naturally occurring lattice systems are limited to the 14 Bravais lattices, as a consequence of the limited number of ways in which atoms can be packed on the atomic scale. In contrast, in embodiments of the present invention it is possible to define unit cells within which the arrangement of nodes and struts does not follow the arrangements of atoms and bonds within one of the Bravais lattices. In other embodiments, the arrangement of struts within the unit cell may be irregular or random. For example, in some embodiments the unit cell of a lattice structure may be defined based on a quasicrystal. In quasicrystal-inspired lattice structures, two or more unit cells that are overlapped can be repeated to fill the space within a quasicrystal-like region of the structure by rotating as well as translating the unit cell, since by definition a unit cell cannot fill space through translation alone for a quasicrystal.

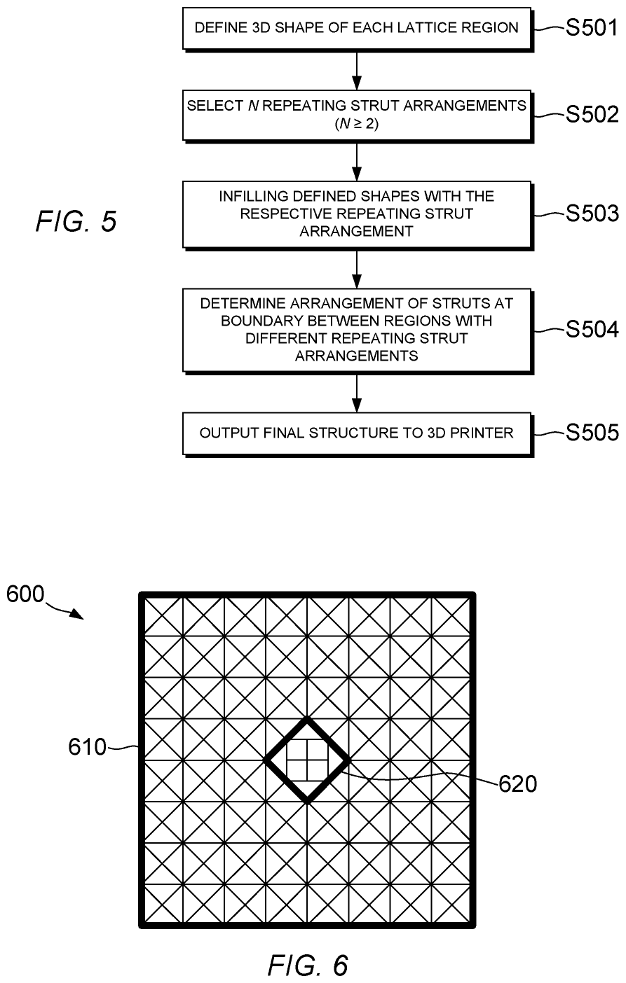

Referring now to FIG. 5, a flowchart is illustrated showing a computer-implemented method of configuring and producing a lattice structure, according to an embodiment of the present invention. Apparatus capable of implementing the method is shown in. FIG. 8. The apparatus 800 comprises a user interface 801 and a processing unit 802. The processing unit 802 comprises computer-readable memory 802a and one or more processors 802b capable of executing computer program instructions stored in the memory 802a. The user interface 801 allows a user to interact with software running on the processing unit 802. For example, the user interface 801 may be embodied as a. graphical user interface (GUI). The steps in the flowchart shown in FIG. 5 may be carried out in software, by means of suitable computer program instructions stored in the memory 802a. In the present embodiment the apparatus 800 is configured to communicate with a 3D printer 810 in order to control the 3D printer 810 to manufacture the resulting lattice structure.

Continuing with reference to FIG. 5, the method starts by defining a three-dimensional shape of each one of the plurality of regions within the lattice structure in step S501. Here, various arrangements of a plurality of regions are possible. For example, in some embodiments a plurality of regions may be arranged to resemble grains in a poly-crystalline structure, as in the embodiment shown in FIG. 1. In other embodiments a plurality of regions may be arranged to resemble different types of microstructure, for example a plurality of precipitates surrounded by a matrix. In step S501, when the lattice structure is being designed to be included in a structural component, the external boundary of the lattice structure can be defined according to the physical dimensions of the component.

Each region may, for example, be designed to have a Voronoi polyhedral shape similar to the morphology of intrinsic crystal grains. Polyhedral cells can be generated using any suitable software program, for example Neper or other suitable computer-aided design (CAD) programs. In other embodiments a region may not have a polyhedral shape. For example, in some embodiments a spherical region may be surrounded and enclosed by a matrix which has a different repeating strut arrangement. In this way, the plurality of regions in the lattice structure can be configured so as to mimic the presence of precipitates in crystalline alloys.

Next, in step S502 the repeating strut arrangement to be used in each region is selected from a plurality of predefined repeating strut arrangements. For example, the predefined repeating strut arrangements may be unit cells with different dimensions and/or of different lattice types. In other embodiments, instead of selecting from a predefined unit cell 111 step S502, the repeating strut arrangement for a region of the lattice structure may be arbitrarily defined. In some embodiments, step S502 may be omitted, for example the software may be configured to use a different default unit cell for each region.

Then, in step S503 the structure is generated by infilling each region with the selected repeating strut arrangement. For example, when a unit cell based on a crystal lattice is used, the unit cell can be repeatedly copied and translated along the crystallographic axes until the space within the defined three-dimensional shape has been filled. During step S503, the anisotropy of the overall lattice structure can be controlled by choosing an appropriate orientation of the lattice in each region.

Next, in step S504 the arrangement of struts at the boundaries between the different regions of the lattice structure is determined. In the present embodiment, once the location of struts and nodes at the edge of each region has been determined in step S503, then in step S504 struts are added which span the boundary regions and connect any mis-oriented lattice struts in neighbouring regions of the structure. In this way, the struts within the boundary region can accommodate any discontinuities between the unit cells in the adjacent regions of the structure. In addition, the lattice orientations in two regions across the boundary can be arranged such that a fraction of the struts belonging to the two regions are co-incident at the boundary. In this way, the coincident struts in the boundary region can be configured so as to mimic the coincident site lattices at boundaries between crystalline grains.

Therefore, in embodiments of the present invention different types of grain boundaries in poly-crystals can be mimicked and manufactured in the macroscopic scale. Because the type of grain boundaries can significantly affect the property of crystals, the introduction of a specific type of boundary into a macroscopic lattice structure can provide an additional mechanism by which the properties of the lattice structure can be controlled, making it possible to design structures with more desirable properties.

When determining the arrangement of struts within a boundary region in step S504, different approaches are possible. For example, in some embodiments struts near the boundary in one grain can be bent in order to connect to a nearby strut in the neighbouring grain. Alternatively, a planar frame constructed from a plurality of struts can be defined within the boundary region, and struts near the boundary in adjacent grains can be connected to the frame without being bent.

Finally, once the final structure has been determined, in step S505 instructions are sent to an additive manufacturing apparatus 810 in order to manufacture the lattice structure. In other embodiments, instead of sending instructions to a 3D printer in step S505 a different action may be taken. For example, a CAD file may be generated which defines the lattice structure, and may be stored in local storage or uploaded to a server over a network. The stored CAD file could then be retrieved at a later date when it is desired to produce a physical copy of the lattice structure. Furthermore, instead of using 3D printing to produce the lattice structure, in other embodiments in step S505 any suitable fabrication apparatus could be controlled to produce the lattice structure.

Referring now to FIG. 6, a lattice structure comprising one region surrounded and enclosed by another region with a different strut arrangement is illustrated, according to an embodiment of the present invention. In this embodiment, the lattice structure 600 comprises a first region 610 which acts as a matrix, surrounding and enclosing multiple smaller regions, for example a second region 620 which has a different repeating strut arrangement. The second region 620 can be referred to as a ‘precipitate’, by analogy with precipitation-hardened alloys. In the present embodiment the second region 620 has a BCC unit cell and the first region 610 has a FCC unit cell. In other embodiments the precipitate and the matrix may have the same type of unit cell but different lattice parameters, and/or different lattice orientations. In some embodiments, the precipitate can be configured to have an auxetic structure that has a negative Poisson ratio and can change its shape during deformation, so as to deflect and control the propagation of shear bands which may form in the surrounding matrix.

Referring now to FIG. 7, a graph is illustrated comparing the strength of a lattice structure comprising a plurality of precipitates, according to an embodiment of the present invention, against a single cell lattice structure. In the present embodiment, the lattice structure is designed so as to resemble a superlattice of gamma (γ) and a plurality of gamma-prime (γ′) precipitates in Ni-based superalloys. Lattice structures such as the one shown in FIG. 6, comprising a precipitate with one unit cell embedded in a matrix with a different unit cell so as to block propagation of shear bands across the structure, may therefore be referred to generally as ‘superlattice’ structures. The curves plotted in FIG. 7 were obtained by mechanical testing on 3D-printed samples of (i) a ‘superlattice’ structure comprising a first region (matrix), which resembles the face-centred-cubic γ phase, enclosing second regions (precipitates), which are analogous to the γ′ phase, and (ii) a single-cell lattice structure comprising just a single repeating unit, similar to conventional single-oriented lattice structures. The superlattice structure for which data is plotted in FIG. 7 comprises a total of 20 precipitates, however, it will be appreciated that this is merely an example and that different numbers of precipitate-like regions may be included in other embodiments. As shown in FIG. 7, the inclusion of multiple γ′ precipitates with a different repeating strut arrangement results in a substantial increase in strength, as the stress required to give a certain compression of the structure is significantly increased.

By using different strut arrangements within different regions of the lattice structure, the crack resistance of the structure can be improved, since regions configured as grain boundaries, particles and/or phases can stop the propagation of shear bands across the structure. In addition, by controlling the strut orientations and lattice types, compliant structures with desirable anisotropy can be manufactured. Such structures may be particularly desirable in medical device applications.

Embodiments of the present invention have been described in which lattice structures are engineered in such a way as to improve the mechanical properties of the structure in comparison to conventional lattice structures. The principles disclosed herein can enable the design and manufacture of lightweight, tough and resilient additive manufacturing products. Similarly, the principles disclosed herein can be adopted to control other physical properties such as vibration or optical reflection. For example, recent improvements in 3D printing techniques have enabled the manufacture of lattice structures on the nanometre length scale. In some embodiments of the present invention, such techniques may be used to produce a lattice structure that is designed to resemble a crystal-like metamaterial, in order to tailor the optical properties of the lattice structure. Therefore the advantages provided by embodiments of the present invention are not limited to the mechanical properties of lattice structures, but can also extend to other properties of the structure. Lattice structures designed according to aspects of the present invention can be incorporated into structural components for a wide range of applications, including but not limited to aero, automotive, defence, medical device and civil engineering applications. Such structural components can be used in a wide variety of multi-component products, such as consumer products, industrial machinery, road vehicles, aeroplanes, satellites, and so on.

Whilst certain embodiments of the invention have been described herein with reference to the drawings, it will be understood that many variations and modifications will be possible without departing from the scope of the invention as defined in the accompanying claims.

1. A lattice structure comprising:
a plurality of struts integrally connected to one another at a plurality of nodes,
wherein the plurality of struts are arranged into at least:
a first region comprising a first repeating strut arrangement;
a second region comprising a second repeating strut arrangement, the first repeating strut arrangement being different to the second repeating strut arrangement; and
a boundary region disposed between the first region and the second region, the boundary region comprising a plurality of struts configured to connect nodes in the first region to nodes in the second region, a strut arrangement in the boundary region being different to the first and second repeating strut arrangements.

2. The lattice structure of claim 1, wherein the first repeating strut arrangement comprises a first repeating unit which is repeated throughout the first region, and the second repeating strut arrangement comprises a second repeating unit which is repeated throughout the second region, and
wherein the first and second repeating units have the same number and arrangement of struts and have different physical dimensions.

3. The lattice structure of claim 1, wherein the first repeating strut arrangement comprises a first repeating unit which is repeated throughout the first region, and the second repeating strut arrangement comprises a second repeating unit which is repeated throughout the second region, wherein a number and/or orientation of struts in the first repeating unit is different to a number and/or orientation of struts in the second repeating unit.

4. The lattice structure of claim 1, wherein at least one of the first repeating strut arrangement and the second repeating strut arrangement is configured based on a crystallographic lattice.

5. The lattice structure of claim 4, wherein the crystallographic lattice is a body-centred cubic BCC lattice, face-centred cubic FCC lattice, or hexagonal close-packed HCP lattice.

6. The lattice structure of claim 4 wherein the first repeating strut arrangement and the second repeating strut arrangement are configured based on different crystallographic lattices.

7. The lattice structure of claim 1, wherein the first region is surrounded and enclosed by the second region.

8. The lattice structure of claim 1, wherein one or more of the plurality of struts in the boundary region are bent to accommodate a discontinuity between the first region and the second region.

9. The lattice structure of claim 8, wherein the first and second repeating strut arrangements are configured such that in the boundary region, at least some of the struts of the first region are coincident with at least some of the struts of the second region.

10. The lattice structure of claim 1, wherein the lattice structure is formed by additive manufacturing.

11. A structural component comprising the lattice structure of claim 1.

12. A multi-component product comprising the structural component according to claim 11.

13. A computer-readable storage medium arranged to store computer program instructions which, when executed, cause an additive manufacturing apparatus to manufacture a lattice structure according to claim 1.

14. A computer-implemented method of configuring a lattice structure comprising a plurality of struts integrally connected to one another at a plurality of nodes, wherein the plurality of struts are arranged into at least a first region comprising a first repeating strut arrangement, a second region comprising a second repeating strut arrangement, the first repeating strut arrangement being different to the second repeating strut arrangement, and a boundary region disposed between the first region and the second region, the boundary region comprising a plurality of struts configured to connect nodes in the first region to nodes in the second region, a strut arrangement in the boundary region being different to the first and second repeating strut arrangements, the method comprising:
defining a three-dimensional shape of each of the first and second regions; and
determining positions and orientations of struts within each of the first and second regions by infilling the respective defined three-dimensional shape with the respective first or second repeating strut arrangement.

15. The method of claim 14, further comprising:
determining the strut arrangement in the boundary region to accommodate a discontinuity between the first and second repeating strut arrangements.

16. The method of claim 14, wherein the first region and/or the second region is defined as having a polyhedral shape.

17. The method of claim 14, further comprising:
selecting each of the first and second repeating strut arrangements from a plurality of predefined repeating strut arrangements.

18. The method of claim 15, wherein each one of the plurality of predefined repeating strut arrangements is configured based on a crystallographic lattice.

19. The method of claim 14, wherein an external boundary of the lattice structure is defined according to physical dimensions of a component in which the lattice structure is to be included.

20. The method of claim 14, further comprising:
controlling a fabrication apparatus to manufacture the lattice structure.

21. The method of claim 20, wherein the fabrication apparatus is an additive manufacturing apparatus.
